(19) United States
(12) Patent Application Publication
(10) Pub. No.: US 2022/0187642 A1
(43) Pub. Date: Jun. 16, 2022

(54) DISPLAY SCREEN AND ELECTRONIC DEVICE

(71) Applicant: Huizhou China Star Optoelectronics Technology Co., Ltd., Huizhou, Guangdong (CN)

(72) Inventors: Dongchen HUANG, Huizhou, Guangdong (CN); Chingyuan CHENG, Huizhou, Guangdong (CN)

(21) Appl. No.: 17/051,459

(22) PCT Filed: Sep. 14, 2020
(86) PCT No.: PCT/CN2020/115012

§ 371 Date: Oct. 29, 2020

(51) Int. Cl. G02F 1/1347; G02F 1/1333; G02F 1/1335

(52) U.S. Cl. CPC G02F 1/1347; G02F 1/133502; G02F 1/133528; G02F 1/13338

(57) ABSTRACT

A display screen and an electronic device are provided. The display screen includes: a first liquid crystal cell, wherein the first liquid crystal cell is used to display an image; a second liquid crystal cell disposed on a light emitting side of the first liquid crystal cell; wherein the second liquid crystal cell is used to achieve a touch function; a first polarizer disposed on one lateral side of the first liquid crystal cell away from the second liquid crystal cell; a second polarizer disposed one lateral side of the second liquid crystal cell away from the first liquid crystal cell.

### FIELD OF INVENTION

The present disclosure relates to the technical field of display, and particularly, to a display screen and an electronic device.

### BACKGROUND OF INVENTION

Conventional large-size display screens are manufactured by combination of a cover plate with a touch panel. A polarizer is disposed between the touch panel and a liquid crystal display panel. Since the electrodes in the touch panel reflect the ambient light, the display effect may be poor when the ambient light is strong.

### SUMMARY OF INVENTION

The present disclosure provides a display screen, which comprises

a first liquid crystal cell, wherein the first liquid crystal cell is used to display an image;

a second liquid crystal cell disposed on a light emitting side of the first liquid crystal cell; wherein the second liquid crystal cell is used to achieve a touch control function;

a first polarizer disposed on one lateral side of the first liquid crystal cell away from the second liquid crystal cell; and

a second polarizer disposed one lateral side of the second liquid crystal cell away from the first liquid crystal cell.

The present disclosure further provides an electronic device comprising the display screen.

The electronic device of the present disclosure comprises a first liquid crystal cell, wherein the first liquid crystal cell is used to display an image; a second liquid crystal cell disposed on a light emitting side of the first liquid crystal cell; wherein the second liquid crystal cell is used to achieve a touch control function; a first polarizer disposed on one lateral side of the first liquid crystal cell away from the second liquid crystal cell; and a second polarizer disposed one lateral side of the second liquid crystal cell away from the first liquid crystal cell. Since the first polarizer and the second polarizer are disposed outside the display screen, the reflection of ambient light may be reduced and thereby enhancing the display effect.

### BRIEF DESCRIPTION OF DRAWINGS

In order to explain the technical solutions of the present disclosure clearly, the following will briefly introduce the drawings used in the description of the embodiments. Obviously, the drawings described below are only some embodiments of the present disclosure. For those skilled in the art, other drawings can be obtained based on these drawings without making creative efforts.

FIG. 1 is a cross-sectional schematic view of a display screen provided by one embodiment of the present disclosure.

FIG. 2 is a cross-sectional schematic view of a display screen provided by another embodiment of the present disclosure.

FIG. 3 is a cross-sectional schematic view of a display screen provided by yet another embodiment of the present disclosure.

FIG. 4 is a cross-sectional schematic view of a display screen provided by yet another embodiment of the present disclosure.

FIG. 5 is a schematic view of an electronic device provided by one embodiment of the present disclosure.

### DETAILED DESCRIPTION OF PREFERRED EMBODIMENTS

The technical solutions of the present disclosure will be described clearly and completely in combined with the drawings of the present disclosure. Obviously, the described embodiments are only one part of the embodiments of the present disclosure, but not all of the embodiments. Based on the embodiments of the present disclosure, all other embodiments obtained by a person skilled in the art without making creative efforts fall within the claim scope of the present disclosure.

In the present disclosure, unless otherwise clearly specified and limited, the first feature “above” or “below” the second feature may include the direct contact of the first and second features, or may also include the first and second features that do not contact directly but through another feature between them. Moreover, the first feature “above”, “on” and “upon” the second feature includes that the first feature is directly above and obliquely above the second feature, or simply means that the horizontal height of the first feature is higher than the horizontal height of the second feature. The first feature “below,” “under,” and “lower” the second feature includes that the first feature is directly below and obliquely below the second feature, or simply means that the horizontal height of the first feature is lower than the horizontal height of the second feature.

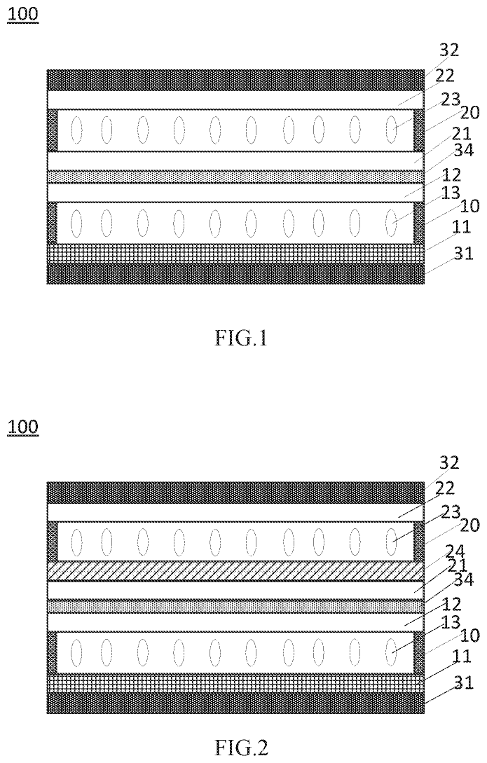

Please refer to FIG. 1 and FIG. 2. FIG. 1 is a cross-sectional schematic view of a display screen provided by one embodiment of the present disclosure.

As shown in FIG. 1, the display screen 100 of the present embodiment comprises a first liquid crystal cell 10, a second liquid crystal cell 20, a first polarizer 31, and a second polarizer 32.

The first liquid crystal cell 10 is used to display an image. In one embodiment, the first liquid crystal cell 10 comprises: a first substrate 11, a second substrate 12, and a first liquid crystal layer 13. The second substrate 12 is disposed opposite the first substrate 11. The second substrate 12 is disposed close to the second liquid crystal cell 20. The first liquid crystal layer 13 is disposed between the first substrate 11 and the second substrate 12, and a periphery of the first substrate 11 is adhered to a periphery of the second substrate 12 by a frame glue. In one embodiment, the first substrate 11 is an array substrate, and the second substrate 12 is a color filter substrate.

The second liquid crystal cell 20 is disposed on a light emitting side of the first liquid crystal cell 10. The second liquid crystal cell 20 is used to achieve a touch control function. In one embodiment, the second liquid crystal cell 20 comprises: a third substrate 21, a fourth substrate 22 and a second liquid crystal layer 23. The third substrate 21 is disposed close to the first liquid crystal cell 10. The fourth substrate 22 is disposed opposite the third substrate 21. The second liquid crystal layer 23 is disposed between the third substrate 21 and the fourth substrate 22, and a periphery of the third substrate 21 is adhered to a periphery of the fourth substrate 22 by a frame glue. As shown in FIG. 2, a touch electrode 24 is disposed on one lateral side of the third substrate 21 close to the second liquid crystal layer 23. In other embodiments, a touch electrode 24 is disposed on one lateral side of the fourth substrate 22 close to the second liquid crystal layer 23. In one embodiment, in order to enhance the stability of the display screen, the first liquid crystal cell 10 is adhered to the second liquid crystal cell 20. The first liquid crystal cell 10 is adhered to the second liquid crystal cell 20 by an optical clear adhesive 34. In one embodiment, a material of the optical clear adhesive 34 may be cyanoacrylate or epoxy resin adhesive. In a preferred embodiment, in order to reduce a thickness of the display screen, a thickness of the second liquid crystal cell 20 is less than a preset thickness, and the preset thickness is a thickness of a conventional cover. For example, the thickness of the cover is 2 mm, and the thickness of the second liquid crystal cell 20 is less than 2 mm.

The first polarizer 31 is disposed on one lateral side of the first liquid crystal cell 10 away from the second liquid crystal cell 20. In one preferred embodiment, the first polarizer 31 is disposed on one lateral side of the first substrate 11 away from the first liquid crystal layer 13. In one embodiment, a material of the first polarizer 31 may be a dichroic organic polymer material. Certainly, the material of the first polarizer 31 is not limited thereto.

The second polarizer 32 is disposed on one lateral side of the second liquid crystal cell 20 away from the first liquid crystal cell 10. In one preferred embodiment, the second polarizer 32 is provided on one lateral side of the fourth substrate 22 away from the second liquid crystal layer 23. In one embodiment, a material of the second polarizer 32 may be the same as the material of the first polarizer 31. In one preferred embodiment, in order to further enhance the display effect, a direction of a transmission axis of the first polarizer 31 is parallel to a direction of a transmission axis of the second polarizer 32.

Since the first polarizer and the second polarizer are disposed outside the display screen, the reflection of ambient light may be reduced and thereby enhancing the display effect. In addition, since the second liquid crystal cell is disposed above the first liquid crystal cell, viewing angles are increased, and the display effect is further enhanced.

Please refer to FIG. 3. FIG. 3 is a cross-sectional schematic view of a display screen provided by yet another embodiment of the present disclosure.

The difference between a display screen of the present embodiment and the display screen of the previous embodiment is that: the display screen 100 of the present embodiment is further provided with a first antireflection layer 41.

In one preferred embodiment, the first antireflection layer 41 is disposed on the lateral side of the fourth substrate 22 away from the second liquid crystal layer 23. In another embodiment, the first antireflection layer 41 may also be disposed on a lateral side of the fourth substrate 22 close to the second liquid crystal layer 23. In one embodiment, in order to further reduce the reflection of ambient light, a thickness range of the first antireflection layer 41 may be between 20 nm and 150 nm. In one embodiment, in order to further reduce the reflection of ambient light, the first antireflection layer 41 is made of polyimide polymer or polyimide derivatives.

Since on the basis of the previous embodiment, the first antireflection film 41 is disposed above or below the fourth substrate 22, the reflection of ambient light is thus further reduced, thereby further enhancing the display effect.

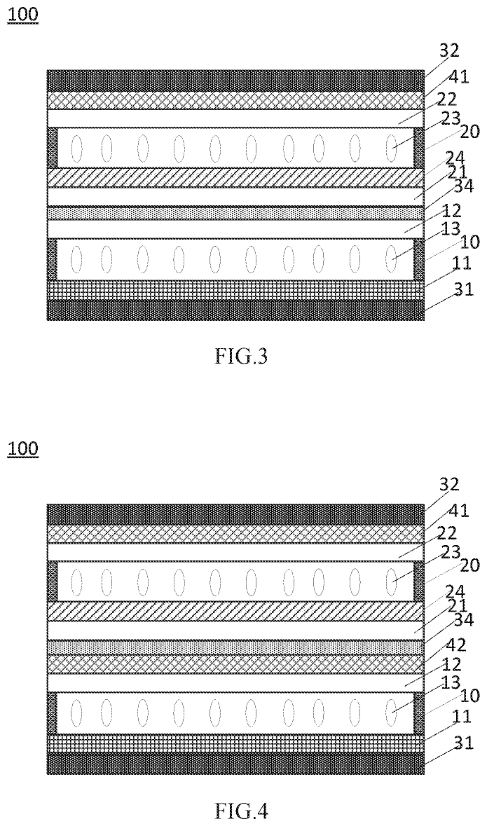

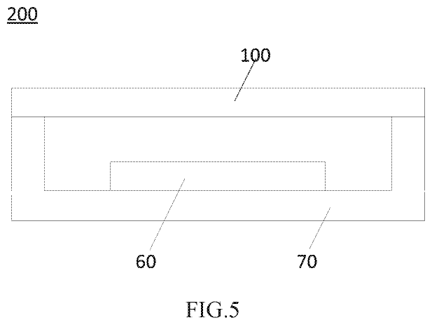

Please refer to FIG. 4. FIG. 4 is a cross-sectional schematic view of a display screen provided by yet another embodiment of the present disclosure.

The difference between a display screen of the present embodiment and the display screen of the previous embodiment is that: the display screen 100 of the present embodiment is further provided with a second antireflection layer 42.

In a preferred embodiment, the second antireflection layer 42 is disposed on one lateral side of the second substrate 12 away from the first liquid crystal layer 13. In another embodiment, the second antireflection layer 42 is disposed on the lateral side of the second substrate 12 close to the first liquid crystal layer 13. In other embodiments, the second antireflection layer 42 may also be disposed on the top of the first substrate 11. A material of the second antireflection layer 42 may be the same as a material of the first antireflection layer 41.

Since on the basis of the previous embodiment, the second antireflection layer 42 is disposed above or below the second substrate 12, the reflection of ambient light is thus further reduced, thereby further enhancing the display effect.

Certainly, it is anticipated that in other embodiments, the second antireflection layer may be disposed in the display screen 100, but the first antireflection layer is not provided.

Please refer to FIG. 5. FIG. 5 is a schematic view of an electronic device provided by one embodiment of the present disclosure. The electronic device 200 may comprise a display screen 100, a control circuit 60, and a housing 70. It should be noted that the electronic device 200 shown in FIG. 5 is not limited to the content described above, which may also comprise other devices. For example, the electronic device 200 may also comprise a camera, an antenna structure, a fingerprint unlocking module, etc.

The display screen 100 is disposed on the housing 70.

In some embodiments, the display screen 100 may be fixed to the housing 70. The display screen 100 and the housing 70 form a closed space to accommodate components such as the control circuit 60.

In some embodiments, the housing 70 may be made of a flexible material, such as a plastic housing or a silicone housing.

The control circuit 60 is installed in the housing 70. The control circuit 60 may be a main board of the electronic device 200. The control circuit 60 can be integrated with one, two or more of functional components of a battery, an antenna structure, a microphone, a speaker, a headphone interface, a universal serial bus interface, a camera, a distance sensor, an ambient light sensor, a receiver, and a processor.

The display screen 100 is installed in the housing 70. Moreover, the display screen 100 is electrically connected to the control circuit 60 to form a display screen of the electronic device 200. The display screen 100 may comprises a display region and a non-display region. The display region may be used to display an image of the electronic device 200 or for a user to perform touch manipulation. The non-display region can be used to set various functional components.

The electronic device includes, but is not limited to, a mobile phone, a tablet computer, a computer monitor, a game console, a television, a wearable device, and other life appliances or household appliances with display functions.

The display screen and the electronic device of the present disclosure comprise the first liquid crystal cell, wherein the first liquid crystal cell is used to display an image; the second liquid crystal cell disposed on the light emitting side of the first liquid crystal cell, wherein the second liquid crystal cell is used to achieve the touch control function; the first polarizer disposed on the lateral side of the first liquid crystal cell away from the second liquid crystal cell; the second polarizer disposed on the second liquid crystal cell away from the first liquid crystal cell. Since the first polarizer and the second polarizer are disposed outside the display screen, the reflection of ambient light may be reduced and thereby enhancing the display effect.

The display screen and the electronic device provided by the present disclosure are described in detail above. Specific examples are used herein to illustrate the principles and embodiments of the present application. The description of the above embodiments is only used to help understand the present application. Moreover, for those skilled in the art, according to an concept of the present application, the specific embodiments and the scope of application may be modified. In summary, the content of the present specification should not be construed as a limitation of the application.

What is claimed is:

1. A display screen, comprising:
a first liquid crystal cell, wherein the first liquid crystal cell is used to display an image;
a second liquid crystal cell disposed on a light emitting side of the first liquid crystal cell; wherein the second liquid crystal cell is used to achieve a touch control function;
a first polarizer disposed on one lateral side of the first liquid crystal cell away from the second liquid crystal cell; and
a second polarizer disposed one lateral side of the second liquid crystal cell away from the first liquid crystal cell.

2. The display screen according to claim 1, wherein the second liquid crystal cell comprises:
a third substrate, wherein the third substrate is disposed close to the first liquid crystal cell;
a fourth substrate, wherein the fourth substrate is disposed opposite the third substrate; and
a second liquid crystal layer disposed between the third substrate and the fourth substrate; wherein a touch electrode is disposed on one lateral side of the fourth substrate close to the second liquid crystal layer or one lateral side of the third substrate close to the second liquid crystal layer.

3. The display screen according to claim 2, wherein the second polarizer is disposed on one lateral side of the fourth substrate away from the second liquid crystal layer.

4. The display screen according to claim 1, wherein a first antireflection layer is disposed on the lateral side of the fourth substrate away from the second liquid crystal layer.

5. The display screen according to claim 4, wherein a thickness range of the first antireflection layer may be between 20 nm and 150 nm.

6. The display screen according to claim 1, wherein the first liquid crystal cell comprises:
a first substrate;
a second substrate, wherein the second substrate is disposed opposite the first substrate; and the second substrate is close to the second liquid crystal cell; and
a first liquid crystal layer disposed between the first substrate and the second substrate, and the first polarizer is disposed on one lateral side of the first substrate away from the first liquid crystal layer.

7. The display screen according to claim 6, wherein a second antireflection layer is disposed on the lateral side of the second substrate away from the first liquid crystal layer.

8. The display screen according to claim 1, wherein a direction of a transmission axis of the first polarizer is parallel to a direction of a transmission axis of the second polarizer.

9. The display screen according to claim 1, wherein the first liquid crystal cell is adhered to the second liquid crystal cell by an optical clear adhesive.

10. The display screen according to claim 1, wherein a thickness of the second liquid crystal cell is less than a preset thickness.

11. An electronic device, comprising a display screen, wherein the display screen comprises:
a first liquid crystal cell, wherein the first liquid crystal cell is used to display an image;
a second liquid crystal cell disposed on a light emitting side of the first liquid crystal cell; wherein the second liquid crystal cell is used to achieve a touch control function;
a first polarizer disposed on one lateral side of the first liquid crystal cell away from the second liquid crystal cell; and
a second polarizer disposed one lateral side of the second liquid crystal cell away from the first liquid crystal cell.

12. The electronic device according to claim 11, wherein the second liquid crystal cell comprises:
a third substrate, wherein the third substrate is disposed close to the first liquid crystal cell;
a fourth substrate, wherein the fourth substrate is disposed opposite the third substrate; and
a second liquid crystal layer disposed between the third substrate and the fourth substrate; wherein a touch electrode is disposed on one lateral side of the fourth substrate close to the second liquid crystal layer or one lateral side of the third substrate close to the second liquid crystal layer.

13. The electronic device according to claim 12, wherein the second polarizer is disposed on one lateral side of the fourth substrate away from the second liquid crystal layer.

14. The electronic device according to claim 11, wherein a first antireflection layer is disposed on the lateral side of the fourth substrate away from the second liquid crystal layer.

15. The electronic device according to claim 14, wherein a thickness range of the first antireflection layer may be between 20 nm and 150 nm.

16. The electronic device according to claim 11, wherein the first liquid crystal cell comprises:
a first substrate;
a second substrate, wherein the second substrate is disposed opposite the first substrate; and the second substrate is close to the second liquid crystal cell; and
a first liquid crystal layer disposed between the first substrate and the second substrate, and the first polarizer is disposed on one lateral side of the first substrate away from the first liquid crystal layer.

17. The electronic device according to claim 16, wherein a second antireflection layer is disposed on the lateral side of the second substrate away from the first liquid crystal layer.

18. The electronic device according to claim 11, wherein a direction of a transmission axis of the first polarizer is parallel to a direction of a transmission axis of the second polarizer.

19. The electronic device according to claim 11, wherein the first liquid crystal cell is adhered to the second liquid crystal cell by an optical clear adhesive.

20. The electronic device according to claim 11, wherein a thickness of the second liquid crystal cell is less than a preset thickness.
